(19) United States
(12) Patent Application Publication
(10) Pub. No.: US 2018/0125036 A1
(43) Pub. Date: May 10, 2018

(54) Retractable multifunctional dog leash

(71) Applicant: Jinhuai PANG, Guangdong (CN)

(72) Inventor: Jinhuai PANG, Guangdong (CN)

(21) Appl. No.: 15/794,010

(22) Filed: Oct. 26, 2017

(30) Foreign Application Priority Data
Nov. 8, 2016 (CN) 201621203637.1

(51) Int. Cl. A01K 27/00

(52) U.S. Cl. CPC A01K 27/004; B65H 75/406; A01K 27/009

(57) ABSTRACT

A retractable multifunctional dog leash that contains an outer shell, a retractable rope in the outer shell, and a position limiting stopper at a front end of the retractable rope to prevent the retractable rope from completely retracting back into the outer shell. A roller device releasing and retracting the retractable rope is provided inside the outer shell; a sound generator is also provided on the outer shell to generate sound directly. The dog leash is easy to carry and use, and its retractable rope can be easily adjusted to extend and retract as desired

### BACKGROUND OF THE INVENTION

The present invention relates to the field of pet product, and more specifically relates to a retractable multifunctional dog leash.

Following the enhancement of living standard, pet keeping has become a trend. Dog is the most common pet. Walking a dog is necessary for keeping a dog. Although some small dogs do not need to be restrained by ropes, ropes are still required to restrain small dogs in many occasions out of for example safety reasons. Also, a sound generator is usually brought with the owner when walking a dog in order to call the dog by sound no matter if the dog is near to or away from the owner. The existing dog leashes in the market are mono-functional where only a rope is installed inside; it is therefore very troublesome to call the pet if the owner forgets to bring along a sound generating device such as a whistle or a clicker when walking a dog. Even when the owner brings along the sound generating device, it is not convenient for the owner to operate a sound generating device and to keep it while walking a dog.

### BRIEF SUMMARY OF THE INVENTION

In view of the aforesaid disadvantages now existing in the prior art, it is an object of the present invention to provide a retractable multifunctional dog leash which can produce sound directly and which is easy to carry and convenient to use. The rope of the dog leash is freely retractable and its length is convenient to adjust.

The present invention has the following technical solution: A retractable multifunctional dog leash, comprising an outer shell, a retractable rope provided inside the outer shell, and a position limiting stopper provided at a front end of the retractable rope to prevent the retractable rope from completely retracting back into the outer shell; a roller device releasing and retracting the retractable rope is provided inside the outer shell; a sound generator is also provided on the outer shell.

Preferably, a locking device that fixes a position of the retractable rope is provided on the outer shell.

Preferably, the locking device comprises a driving block provided on the outer shell, and a locking block provided at a lower end of the driving block; the locking block is capable of locking the roller device via the driving block which is capable of moving back and forth.

Preferably, the sound generator comprises a first sound generating device and a second sound generating device; the first sound generating device is provided on the outer shell; a rotating seat is provided between the outer shell and the second sound generating device; the second sound generating device is provided inside the rotating seat.

Preferably, the rotating seat and the outer shell are rotatably connected via a rotating shaft; the rotating seat is capable of rotating by 0-90 degrees with respect to the outer shell towards either side.

Preferably, an outer cover is provided on the rotating seat to cover a top end surface of the second sound generating device to which the outer cover attach.

Preferably, a control mechanism for extending and retracting the first sound generating device is provided below the first sound generating device.

Preferably, the roller device adopts a coil spring mechanism to retract the retractable rope.

Preferably, the first sound generating device is a whistle; the second sound generating device is a clicker.

Preferably, a curved through hole is provided on the outer shell; a handle for gripping is formed between the through hole and the outer shell.

### Beneficial Effects

Compared with the prior arts, the retractable multifunctional dog leash according to the present invention has one end of the retractable rope tied to the dog; the roller device can automatically release or retract the retractable rope based on a distance between the pet dog and the dog leash; and the locking device fixes the length of the retractable rope; as such, the length of the retractable rope 11 being released can be controlled at any time, and this overcomes the inconvenience of releasing and retracting the rope manually by hand operation and to hold the retracted rope by hand while walking the pet dog. According, walking a dog becomes easier, relaxing and even stylish. By mounting sound generating devices such as the whistle and the clicker onto the outer shell, the resulting dog leash is more convenient to carry and to use. By mounting two sound generating devices, one of them may still work in case another one fails, so that a situation where no sound can be produced while walking a dog will not occur. By using the whistle and the clicker, the owner can give out different commands to the pet and to call the pet from a distant location.

### BRIEF DESCRIPTION OF THE DRAWINGS

FIG. 1 shows an external structure of the present invention.

FIG. 2 shows an internal structure of the present invention.

FIG. 3 shows an external structure of the present invention with the outer cover turned outside down.

In the figures: 1—curved through hole; 2—control mechanism; 3—first sound generating device; 4—outer shell; 5—sound generator; 6—second sound generating device; 7—rotating seat; 8—driving block; 9—locking device; 10—locking block; 11—retractable rope; 12—position limiting stopper; 13—roller device; 14—outer cover; 15—handle

### DETAILED DESCRIPTION OF THE INVENTION

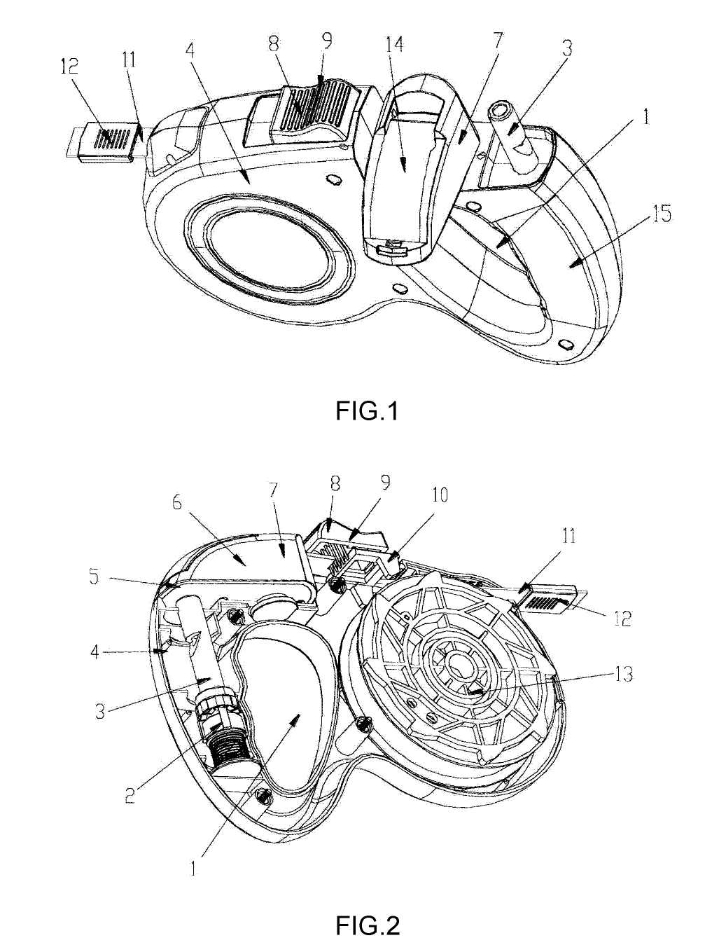

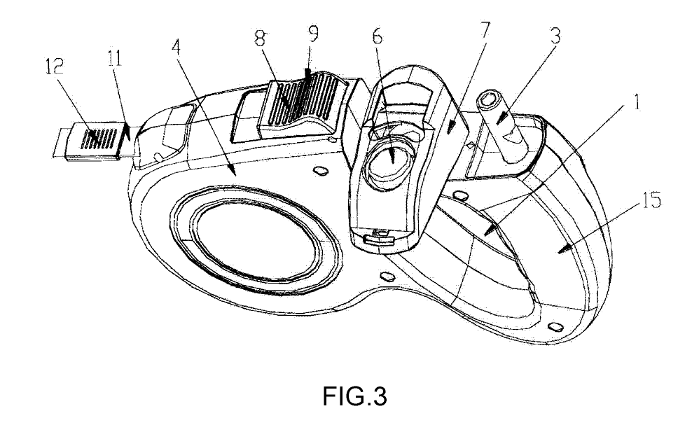

The present invention will be further described in detail below with reference to an embodiment and the accompanying drawings. As shown in FIGS. 1-3, a retractable multifunctional dog leash comprises an outer shell 4, a retractable rope 11 provided inside the outer shell 4, and a position limiting stopper 12 provided at a front end of the retractable rope 11 to prevent the retractable rope 11 from completely retracting back into the outer shell 4; a roller device 13 releasing and retracting the retractable rope 11 is provided inside the outer shell 4; a sound generator 5 is also provided on the outer shell.

While walking a dog, owner may tie the retractable rope 11 of the dog leash to a pet dog, and a distance between the dog and the owner can be controlled by releasing or retracting the retractable rope 11 with respect to the outer shell 4 according to a desired distance between the owner and the pet dog, so that the pet dog only moves within a designated area around the owner. The roller device 13 inside the outer shell 4 can automatically retract the retractable rope 11, such that a constant linear distance is maintained between the outer shell 4 and the retractable rope 11 when the pet dog is running. The retractable rope 11 can also be automatically released according to the running of the pet dog. As such, the rope of the dog leash is managed in a more reasonable and convenient manner. By using the position limiting stopper 12, the retractable rope 11 will not be completely retracted back inside the outer shell 4 under normal operating conditions, thereby facilitating convenient use of the retractable rope 11. In general, a pet dog may be called by the owner or may receive simple training from the owner via sounds produced by the owner using a whistle or a clicker. The pet dog will therefore return to its owner or perform a trick. A sound generator 5 is provided on the outer shell 4 to directly produce sound to call or train the pet dog. Accordingly, the owner will not have to worry about forgetting to bring a sound generator resulting in the difficulty of quickly calling back the pet dog when the pet dog runs far away from the owner without a restraining rope; also when the pet dog is near by, the pet dog can be trained of simple tricks such as jumping, crouching and shaking hands etc; further, the problem of inconvenience of carrying an extra object during pet walking is solved.

Preferably, a locking device 9 that fixes a position of the retractable rope 11 is provided on the outer shell 4.

The locking device 9 is provided on the outer shell 4 such that when the retractable rope 11 is tied to the dog when walking the dog, a length of the retractable rope 11 being released can be fixed at any time. The locking device 9 can timely fix the length of the retractable rope 11.

Preferably, the locking device 9 comprises a driving block 8 provided on the outer shell 4, and a locking block 10 provided at a lower end of the driving block 8; the locking block 10 is capable of locking the roller device 13 via the driving block 8 which is capable of moving back and forth.

When fixing the length of the retractable rope 11 by using the locking device 9, the back and forth movement of the driving block 8 causes a movement of the locking block 10 which then locks the roller device 13, so that the roller device 13 will no longer retract the retractable rope 11, thereby fixing the length of the retractable rope 11. The locking device 9 may also move laterally leftward or rightward to lock the roller device 13, so as to control the length of the retractable rope 11.

Preferably, the sound generator 5 comprises a first sound generating device 3 and a second sound generating device 6; the first sound generating device 3 is provided on the outer shell 4; a rotating seat 7 is provided between the outer shell 4 and the second sound generating device 6; the second sound generating device 6 is provided inside the rotating seat 7.

The sound generator 5 uses two sound generating devices; when one of them fails, another one will complement to beep; the failed sound generating device can be directly replaced when returning back home after walking the dog. This configuration effectively solves the problem of lacking a sound generator for calling the pet dog while walking the pet dog. In normal operating conditions, a top end of the first sound generating device 3 is covered by the rotating seat 7 so that the dog leash has a more pleasing appearance. When the second sound generating device 6 fails, the rotating seat 7 can be rotated to a certain angle towards either side to expose the first sound generating device 3 which can then be used for calling the pet dog; further, the first sound generating device 3 and the second sound generating device 6 can produce different sounds to give out different commands to the pet dog.

Preferably, the rotating seat 7 and the outer shell 4 are rotatably connected via a rotating shaft; the rotating seat 7 is capable of rotating by 0-90 degrees with respect to the outer shell 4 towards either side.

If the first sound generating device 3 is to be used, rotate the rotating seat 7 so that the first sound generating device is exposed and can be used by the owner to call the pet or to give out different commands to the pet; if the second sound generating device 6 fails, the rotating seat 7 can be rotated with respect to the outer shell 4 by 0-90 degrees towards either side. Therefore, the adjustment and manipulation of the rotating seat 7 is much easier.

Preferably, an outer cover 14 is provided on the rotating seat 7 to cover a top end surface of the second sound generating device 6 to which the outer cover 14 attach.

The outer cover 14 can be turned upside down; when it is required to use the second sound generating device 6, turn the outer cover 14 upside down to expose the second sound generating device 6; the outer cover 14 can also prevent the owner from accidentally pressing the second sound generating device 6, and can provide a more integral and pleasing appearance of the dog leash with a perfectly smooth outer contour.

Preferably, a control mechanism 2 for extending and retracting the first sound generating device 3 is provided below the first sound generating device 3.

Preferably, the first sound generating device 3 is provided inside the outer shell 4 in normal circumstances. If it is required to use the first sound generating device 3, press the first sound generating device 3 once so that the control mechanism 2 extends the first sound generating device 3 upwardly for easier use by the owner. When it is not required to use the first sound generating device 3, press the first sound generating device 3 once again so that the control mechanism 2 retracts the first sound generating device back into the outer shell 4. Accordingly, the dog leash can have a smaller size.

Preferably, the roller device 13 adopts a coil spring mechanism to retract the retractable rope 11.

The roller device 13 adopts a coil spring mechanism to retract the retractable rope 11 to attain a simpler structure which can be produced at a lower cost and can achieve a better releasing and retracting effect.

Preferably, the first sound generating device 3 is a whistle; the second sound generating device 6 is a clicker.

When the owner walks a dog, the use of whistle and clicker enables wider scope of applications and their structures corresponds more to living habits. Further, the second sound generating device 6 is a clicker which can give out different commands to the pet to perform different tricks based on the number of times and/or frequency of the clicking sound. Since the clicker is quieter, the first sound generating device 3 which can produce louder sound is used instead to cover a longer calling distance when the pet is asleep or runs far away from the owner.

Preferably, a curved through hole 1 is provided on the outer shell 4; a handle 15 for gripping is formed between the through hole 1 and the outer shell 4.

While walking the pet dog, the curved through hole 1 and the outer shell 4 enhances the portability of the dog leash.

During use, one end of the retractable rope 11 is tied to the dog; the roller device 13 can automatically release or retract the retractable rope 11 based on a distance between the pet dog and the dog leash; and the locking device 9 fixes the length of the retractable rope 11; as such, the length of the retractable rope 11 being released can be controlled at any time, and this overcomes the inconvenience of releasing and retracting the rope manually by hand operation and to hold the retracted rope by hand while walking the pet dog. According, walking a dog becomes easier, relaxing and even stylish. By mounting sound generating devices such as the whistle and the clicker onto the outer shell 4, the resulting dog leash is more convenient to carry and to use. By mounting two sound generating devices, one of them may still work in case another one fails, so that a situation where no sound can be produced while walking a dog will not occur.

The technical solution and concept as described above can be changed and varied by a person skilled in this field of art, and all the changes and variations should also fall within the scope of protection of the claims of the present invention.

What is claimed is:

1. A retractable multifunctional dog leash, comprising an outer shell, a retractable rope provided inside the outer shell, and a position limiting stopper provided at a front end of the retractable rope to prevent the retractable rope from completely retracting back into the outer shell; wherein a roller device releasing and retracting the retractable rope is provided inside the outer shell; a sound generator is also provided on the outer shell.

2. The retractable multifunctional dog leash according to claim 1, wherein a locking device that fixes a position of the retractable rope is provided on the outer shell.

3. The retractable multifunctional dog leash according to claim 2, wherein the locking device comprises a driving block provided on the outer shell, and a locking block provided at a lower end of the driving block; the locking block is capable of locking the roller device via the driving block which is capable of moving back and forth.

4. The retractable multifunctional dog leash according to claim 1, wherein the sound generator comprises a first sound generating device and a second sound generating device; the first sound generating device is provided on the outer shell; a rotating seat is provided between the outer shell and the second sound generating device; the second sound generating device is provided inside the rotating seat.

5. The retractable multifunctional dog leash according to claim 4, wherein the rotating seat and the outer shell are rotatably connected via a rotating shaft; the rotating seat is capable of rotating by 0-90 degrees with respect to the outer shell towards either side.

6. The retractable multifunctional dog leash according to claim 4, wherein an outer cover is provided on the rotating seat to cover a top end surface of the second sound generating device to which the outer cover attach.

7. The retractable multifunctional dog leash according to claim 4, wherein a control mechanism for extending and retracting the first sound generating device is provided below the first sound generating device.

8. The retractable multifunctional dog leash according to claim 1, wherein the roller device adopts a coil spring mechanism to retract the retractable rope.

9. The retractable multifunctional dog leash according to claim 4, wherein the first sound generating device is a whistle; the second sound generating device is a clicker.

10. The retractable multifunctional dog leash according to claim 1, wherein a curved through hole is provided on the outer shell; a handle for gripping is formed between the through hole and the outer shell.
